(19) United States
(12) Patent Application Publication
(10) Pub. No.: US 2016/0098542 A1
(43) Pub. Date: Apr. 7, 2016

(54) MEDICAL DIAGNOSIS AND TREATMENT SUPPORT APPARATUS, SYSTEM, AND METHOD

(71) Applicant: BRIGHT.MD INC., Portland, OR (US)

(72) Inventors: RAYMOND A. COSTANTINI, Beaverton, OR (US); MARK L. SWINTH, Portland, OR (US); CORY D. DODT, Portland, OR (US); ASHLEY S. FISHER, Portland, OR (US); NATHAN P. COOPER, Portland, OR (US)

(21) Appl. No.: 14/871,767

(22) Filed: Sep. 30, 2015

Related U.S. Application Data
(60) Provisional application No. 62/058,588, filed on Oct. 1, 2014.

(51) Int. Cl. G06F 19/00

(52) U.S. Cl. CPC G06F 19/363; G06F 19/3456; G06F 19/3487

(57) ABSTRACT

Embodiments of the inventive concept provide an automated medical computer logic apparatus, which can provide automated medical diagnosis and treatment support to HCPs and patients. A patient can indicate a chief complaint such as chest pain, ear discomfort, a rash, or the like. A rules engine can include clinical modules and a module selector. The module selector can receive the chief complaint and select a particular clinical module. An evaluator logic section can receive and process the selected clinical module. Based on the selected clinical module, the evaluator logic section can cause a dynamic interview to be conducted with the patient, and can map individual question responses to various possible diagnoses, indicating how much each diagnosis should be weighted. The evaluator logic section can suggest treatment options. The automated medical computer logic apparatus can analyze patient responses and automatically generate a customized treatment plan, an automated chart note narrative, a detailed clinical summary, and/or patient education information.

### RELATED APPLICATION DATA

This application claims the benefit of U.S. Provisional Application Ser. No. 62/058,588, filed on Oct. 1, 2014, which is hereby incorporated by reference.

### TECHNICAL FIELD

This application pertains to an automated medical computer logic apparatus, system, and method, and more particularly, to a medical diagnosis and treatment support apparatus, system, and method.

### BACKGROUND

With aging populations and looming retirements of millions of people from among the Baby Boom generation, expenditures in health care are poised to soar. While the increases are widely expected, few solutions exist today to grapple with such large challenges, and relatively few new solutions are being developed. National budgets are expected to be confronted with such massive demographic shifts, and even jeopardized by such inevitable changes.

Meanwhile, health care providers (HCPs) spend a disproportionate amount of time on low-level clinical and administrative tasks, including asking predictable, algorithmic questions, documenting patient responses by hand, manually ordering medications and tests, and providing educational materials on paper to patients. The interests of health care providers, insurance companies, and patients are presently misaligned, which causes inefficiencies and tension, or even worse, poorly delivered and ineffective care. Conventional health care diagnosis and treatment includes costly in-person visits, many of which are unnecessary.

Accordingly, a need remains for improved apparatuses, methods, and systems for efficiently determining medical diagnosis and for providing treatment support. Embodiments of the invention address these and other limitations in the prior art.

### BRIEF DESCRIPTION OF THE DRAWINGS

FIG. 1 illustrates an example block diagram of an automated medical computer logic apparatus in accordance with various embodiments of the present invention.

FIG. 2 illustrates an example block diagram of a rules engine included in the automated medical computer logic apparatus of FIG. 1.

FIG. 3 illustrates an example block diagram of a customized treatment plan, an electronic medical record (EMR) update, an automated chart note narrative, and a detailed clinical summary, generated by the automated medical computer logic apparatus of FIG. 1, and which are storable in different storage databases in accordance with various embodiments of the present invention.

FIG. 4 shows a flow diagram illustrating a technique for performing a medical evaluation in accordance with various embodiments of the present invention.

FIG. 5 shows a flow diagram illustrating a technique for routing a medical interview in accordance with various embodiments of the present invention.

FIG. 6 shows a flow diagram illustrating a technique for performing a medical interview in accordance with various embodiments of the present invention.

FIG. 7 illustrates an example block diagram of an example automated medical computer logic cloud-based system in accordance with various embodiments of the present invention.

The foregoing and other features of the invention will become more readily apparent from the following detailed description, which proceeds with reference to the accompanying drawings.

### DETAILED DESCRIPTION OF THE EMBODIMENTS

Reference will now be made in detail to embodiments of the inventive concept, examples of which are illustrated in the accompanying drawings. The accompanying drawings are not necessarily drawn to scale. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first diagnosis could be termed a second diagnosis, and, similarly, a second diagnosis could be termed a first diagnosis, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

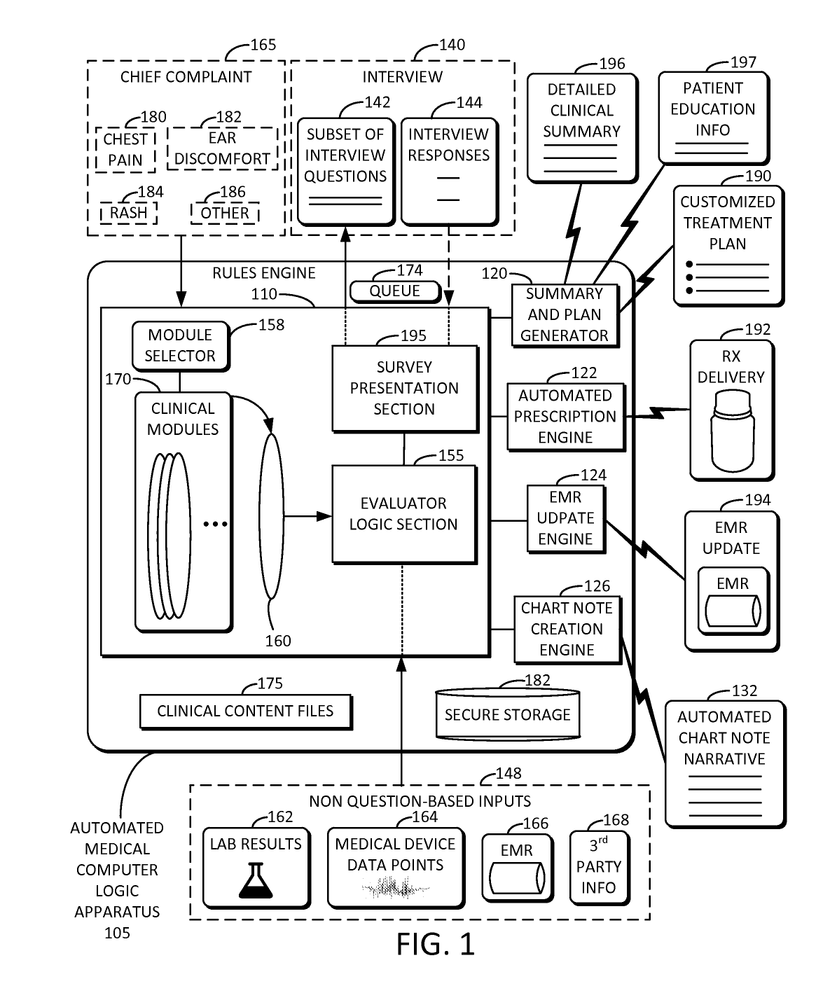

FIG. 1 illustrates an example block diagram of an example automated medical computer logic apparatus 105 in accordance with various embodiments of the present invention. Embodiments of the present invention provide a technological solution and service to health care providers (HCPs) and patients, which allow patients to describe their own signs and symptoms to an automated medical computer logic apparatus 105. The automated medical computer logic apparatus 105 can be an automated medical diagnosis and treatment support apparatus. A patient can initially indicate a chief complaint 165, such as chest pain 180, ear discomfort 182, a rash 184, or some other kind of chief complaint 186, which can be received by the automated medical computer logic apparatus 105.

The automated medical computer logic apparatus 105 can include a rules engine 110 having clinical modules 170 and a module selector 158. The module selector 158 can receive the chief complaint 165, and can select a particular clinical module 160 based on the received chief complaint 165, prior to beginning the dynamic interview 140 with the patient. An evaluator logic section 155 of the rules engine 110 can receive and process the selected clinical module 160. Based on the selected clinical module 160, the evaluator logic section 155 can cause the dynamic interview 140 to be conducted with the patient, which can include interview questions 142 and interview responses 144, as further described below. A survey presentation section 195 can transmit and/or cause the interview questions 142 to be presented on a display, and can gather and/or receive the associated interview responses 144 from the patient via the display or other input device, as also further described in detail below. When completed the interview 140 can be placed on a queue 174, which can then be accessed by an HCP.

The interview questions 142 can be determined based on various factors such as the selected clinical module 160, the interview responses 144, and/or non-question based inputs 148 such as lab results 162, medical device data points 164, an EMR 166, 3^{rd} party information 168, or the like. In other words, the selected clinical module 160, the interview responses 144, and/or the non-question based inputs 148 can be used to determine, by the evaluator logic section 155, which questions (i.e., a selected subset) from among the interview questions 142 associated with the selected clinical module 160 are asked and/or the particular sequencing or selection of the interview questions 142. Put differently, the survey presentation section 195 and/or the evaluator logic section 155 of the rules engine 110 can automatically conduct a dynamic interview (e.g., survey) with the patient, in which each next question is determined based on a continual evaluation that depends on i) previous responses 144 to questions and/or ii) non-question based inputs 148 (e.g., imported or acquired from other sources such as low, normal, or high range lab results 162, averages or discrete data points from medical devices 164, demographic or clinical data from an electronic medical records (EMR) 166, and/or other 3rd party systems 168).

The evaluator logic section 155 of the automated medical computer logic apparatus 105 can map individual question responses 144 and diagnoses, indicating how much each diagnosis should be weighted based on the given answer, and whether or not a particular diagnosis should be ruled out, as further described in detail below. In other words, the evaluator logic section 155 can assign a diagnosis weight to each of the plurality of diagnoses based at least on the responses 144 gathered by the survey presentation section 195. The evaluator logic section 155 of the automated medical computer logic apparatus 105 can determine i) a single suggested diagnosis, including the one diagnosis among various possible diagnoses which has the highest weight or score, ii) multiple suggested diagnoses, when more than one diagnosis is tied with (i.e., equal weights) the highest weight or score, or iii) no diagnosis, when all diagnoses have been ruled out by evaluation of the evaluator logic section 155, as also further described in detail below. The evaluator logic section 155 can suggest treatment options associated with the single suggested diagnosis, as further described below.

The automated medical computer logic apparatus 105 can analyze patient responses and automatically generate a customized treatment plan 190, an automated chart note narrative 132, and/or a detailed clinical summary 196. For example, the automated medical computer logic apparatus 105 can include a summary and plan generator 120, which can automatically generate the customized treatment plan 190 based on the determined diagnosis or diagnoses, based on the interview responses 144, and/or based on the non question-based inputs 148, or the like. Alternatively or in addition, the summary and plan generator 120 can automatically generate the detailed clinical summary 196 based on the determined diagnosis or diagnoses, based on the interview responses 144, and/or based on the non question-based inputs 148, or the like. Alternatively or in addition, the summary and plan generator 120 can automatically generate patient education information 197 based on the determined diagnosis or diagnoses, based on the interview responses 144, and/or based on the non question-based inputs 148, or the like.

By way of another example, the automated medical computer logic apparatus 105 can include a chart note creation engine 126, which can automatically generate the chart note narrative 132 based on the determined diagnosis or diagnoses, based on the interview responses 144, and/or based on the non question-based inputs 148, or the like. The customized treatment plan 190, the automated chart note narrative 132, and/or the detailed clinical summary 196 can be generated in a human readable fashion. In other words, even though the information can be automatically generated, the information can appear as if written by a human, and be readable and understandable by humans, particularly by humans trained in medicine. For example, the chart note narrative 132 can read like and appear as a subjective, objective, assessment, and plan (SOAP) note.

The automated medical computer logic apparatus 105 can include an automated prescription engine 122, which can cause an automated prescription medication (e.g., RX) delivery 192 to the patient and/or an automated prescription authorization 192 to a pharmacy, which can be selected by the patient. A formulary table, as further described below, can indicate a suggested prescription or treatment option, including the specific medication, recommended dosage information, frequency of intake information, or the like.

The automated medical computer logic apparatus 105 can include an EMR update engine 124, which can cause an EMR update 194 to occur. For example, an EMR of the patient can be updated. The automated medical computer logic apparatus 105 can include clinical content files 175 and/or secure storage 182. The EMR or related patient record can be stored in secure storage 182 and/or in a database maintained by an HCP, as further described below.

The automated medical computer logic apparatus 105 can suggest one or more diagnoses and treatment options to one or more HCPs, along with the information needed for the HCP to efficiently make or confirm a diagnosis, provide treatment, and document the visit, as further described below. The automated medical computer logic apparatus 105 can record the HCP's orders and can issue electronic educational content 197 to the patient and, if needed, can automatically provide prescription information to the patient's chosen pharmacy, acting as an automated agent, for example, of the HCP.

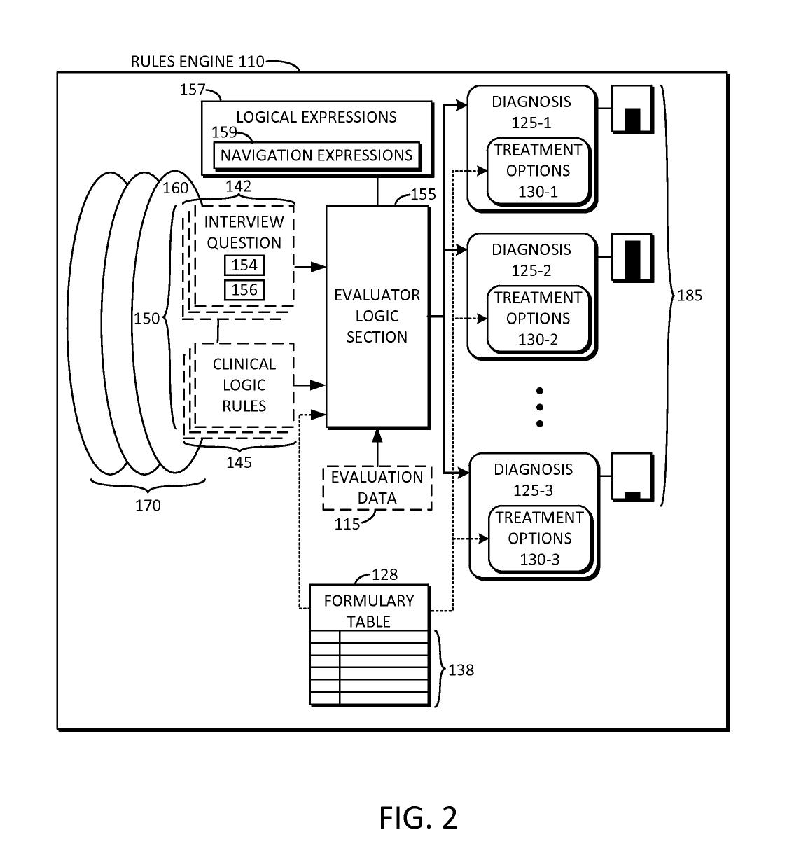

FIG. 2 illustrates an example block diagram of a rules engine 110 included in the automated medical computer logic apparatus 105 of FIG. 1. The selected clinical module 160 from among the clinical modules 170 can include an evaluation 150 having interview questions 142 and clinical logic rules 145. The evaluator logic section 155 can receive the evaluation 150 having the interview questions 142 and the clinical logic rules 145. In addition, the evaluator logic section 155 can receive separate evaluation data 115. The evaluation data 115 can include, for example, the interview responses 144, the non question-based inputs 148, or other suitable data. The evaluator logic section 155 can review and select one or more questions from among the interview questions 142, as a subset of the interview questions 142, to be used in the dynamic interview 140 based on the clinical logic rules 145 and/or the evaluation data 115.

The questions 142 and responses 144 can be combined with other information, to form logical expressions 157, as further described in detail below. The logical expressions 157 can include navigation expressions 159, as also described further below. Each question from among the interview questions 142 can also include a visibility section 156, as further described in detail below. Although shown separately, the logical expressions 157 and/or the navigation expressions 159 can be part of a navigation section 154 of each of the interview questions 142 of the selected clinical module 160. Alternatively or in addition, the logical expressions 157 can be part of the visibility section 156 of each of the interview questions 142 of the selected clinical module 160. Alternatively or in addition, the logical expressions 157 and/or the navigation expressions 159 can be included in and/or generated by the evaluator logic section 155.

The interview questions 142 of the selected clinical module 160 can be associated with the chief complaint 165. The survey presentation section 195 can ask the patient a selected subset of interview questions from among the interview questions 142 of the selected clinical module 160, and can gather responses 144 from the patient to the selected subset of interview questions.

The evaluator logic section 155 can determine one or more diagnosis (e.g., 125-1, 125-2, through 125-3) and/or associated treatment options (e.g., 130-1, 130-2, through 130-3), respectively, based on the selected clinical module 160, the associated interview questions 142, the associated interview responses 144, the associated clinical logic rules 145, the non question-based inputs 148, and/or other evaluation data 115. Each diagnosis (e.g., 125-1, 125-2, through 125-3) can be assigned a corresponding diagnosis weight 185, which can indicate the relative projected accuracy and/or importance of each of the various diagnoses. The diagnostic weights 185 can be expressed, for example, as percentages of a whole and/or as scores. The evaluator logic section 155 can assign the diagnosis weights 185, for example, based on the processing of the selected clinical module 160, the associated interview questions 142, the associated interview responses 144, the associated clinical logic rules 145, the non question-based inputs 148, and/or other evaluation data 115. The evaluator logic section 155 can suggest treatment options (e.g., 130-1, 130-2, through 130-3) associated with a single suggested diagnosis having the highest weight 185. With each response 144 to each interview question 142 (or subset of interview questions), the evaluator logic section 155 can continually adjust the corresponding weights 185 that are assigned to the possible diagnoses (e.g., 125-1, 125-2, through 125-3).

The rules engine 110 can include a formulary table 128, which can include a treatment name and other suitable information such as dosage information, frequency of intake information, and/or other pertinent prescription medication information such as conditions under which a particular drug might be applicable or contraindicated, as further described below. The formulary table 128 can describe medication or treatment options (e.g., 130-1, 130-2, through 130-3), which can treat one or more of the diagnoses (e.g., 125-1, 125-2, through 125-3). The formulary table 128 can include logical expressions 138, groups of medications for a single condition, a suggested default treatment option, or the like, as also further described below. The evaluator logic section 155 can access information in the formulary table 128, process such information, and/or associate such information with each of the diagnoses (e.g., 125-1, 125-2, through 125-3), and/or associate such information with the single suggested diagnosis having the highest weight.

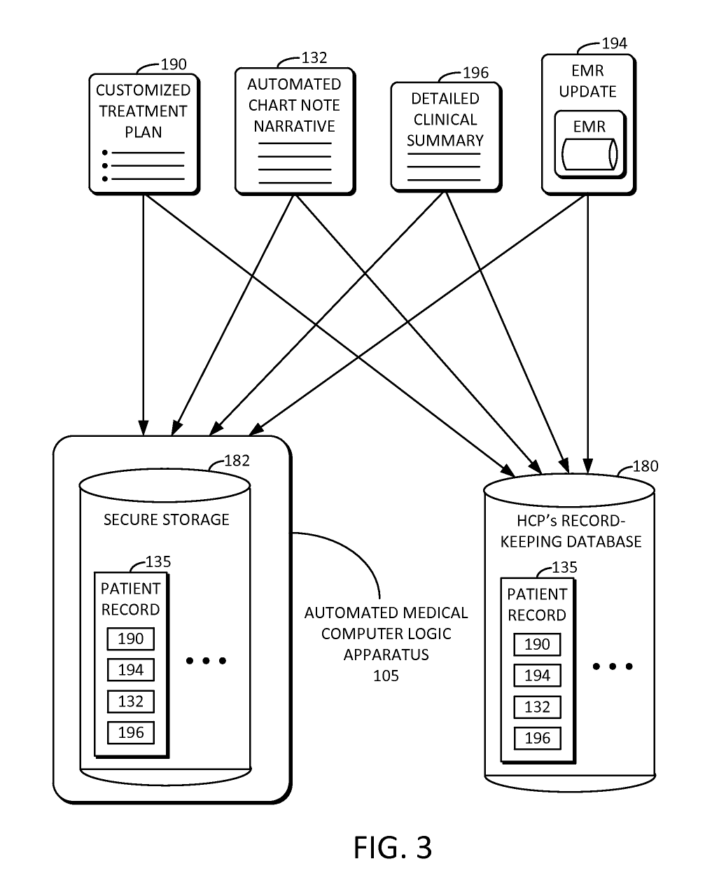

FIG. 3 illustrates an example block diagram of a customized treatment plan 190, an electronic medical record (EMR) update 194, an automated chart note narrative 132, and a detailed clinical summary 196, which can be generated by the automated medical computer logic apparatus 105 of FIG. 1, and which are storable in different storage databases such as the secure storage 182 of the automated medical computer logic apparatus 105 and/or a record-keeping database 180 of the HCP, in accordance with various embodiments of the present invention. In some embodiments, the automated medical computer logic apparatus 105 of (FIG. 1) can generate and/or transmit the customized treatment plan 190, the automated chart note narrative 132, and/or the detailed clinical summary 196, which can be stored in the secure storage 182, the HCP's record-keeping database 180, or both. Moreover, the automated medical computer logic apparatus 105 of (FIG. 1) can cause the EMR update 194 to occur so that the EMR of the patient can be changed to reflect up-to-date information. The patient record 135 can include, for example, the customized treatment plan 190, the automated chart note narrative 132, the detailed clinical summary 196, and/or the EMR 194.

Reference is now made to FIGS. 1 through 3.

### 1 Rules Engine

The automated medical computer logic apparatus 105 can include the rules engine 110, which can evaluate the data 115 against clinical logic rules 145. The clinical logic rules 145 can be described in one or more text files. The results of evaluating the data 115 against the logic rules 145 can be a plurality of weighted diagnoses (e.g., 125-1, 125-2, through 125-3) and their associated treatment options (e.g., 130-1, 130-2, through 130-3). Moreover, human readable documentation that includes, for example, the customized treatment plan 190, the automated chart note narrative 132, and/or the detailed clinical summary 196, which can be appropriate for health care professional (HCP) review, can be generated and stored in a patient medical record 135 of the HCP's record-keeping database 180 and/or in secure storage 182 of the automated medical computer logic apparatus 105.

The rules engine 110 can receive the evaluation 150 including at least two inputs: the interview questions 142 and the clinical logic rules 145. The evaluator logic section 155 can process the interview questions 142 and the clinical logic rules 145 from the evaluation 150. The two sets of evaluation inputs (e.g., 142 and 145) can be sub-components of a single clinical module 160, around a related group of possible low-acuity diagnoses for a single chief complaint 165 (e.g., “ear discomfort,” “rash,” “chest pain,” or the like). Multiple clinical modules 170 can be loaded into the evaluator logic section 155 at runtime, and the chief complaint 165 can act as the first selection made, when choosing which clinical module 170 to use to evaluate the data 115.

### 1.1 Evaluation

### 1.1.1 Interview

The rules engine 110 can receive information to evaluate via the dynamic interview 140. The dynamic interview 140 can include question text (e.g., from among the interview questions 142) associated with a series of possible navigation expressions, forming clinical logic rules 145 that are used to determine which questions (i.e., as a subset of interview questions from among the interview questions 142) a patient should be asked for a given chief complaint 165.

### 1.1.1.1 Question Text

The main text of the selected subset of interview questions 142 of the dynamic interview 140 can describe diagnostic choices to the patient as one or more human-readable questions, with a corresponding series of human-readable answers. The question text can be processed into a sequence of questions, each question having a sequence of responses 144. The questions 142 and/or responses 144 can form logical expressions 157. The logical expressions 157 can be created based on a combination of multiple responses 144, based on other environmental factors such as the date and time that the data was created, and/or based on the number of times the patient has been seen for this condition.

### 1.1.1.2 Navigation Expressions

The interview questions 142 (or subset of the interview questions 142), which can be presented to the patient can optionally and independently be associated with a set of navigation expressions 159, such as the following:

### 1.1.1.2.1 Label

Each interview question 142 can be given a unique label in the text file. The interview questions 142 can represent either one or multiple independent variables, which can be represented as rows. The rows can be given a unique label within the context of that interview question.

### 1.1.1.2.2 Navigation

Each interview question 142 can indicate a navigation that could occur if a particular logical expression matches, for example, that the next interview question 142 to be evaluated should be skipped. A series of these navigation expressions 159 within a single question's context is possible. The series of navigation expressions 159 can be ordered in such a way that each navigation expression 159 in the list can be evaluated separately, one at a time, creating an order of operations so that the navigation expressions 159 need not be nested unnecessarily. Each interview question 142 can include a navigation section 154, which can include the navigation expressions 159.

### 1.1.1.2.3 Visibility

Each interview question 142 and/or interview response 144 may also have a visibility section 156, which can include associated logical expressions (e.g., 157) to determine whether it should be skipped for the purposes of the evaluation 150. The logical expressions (e.g., 157) in this section may indicate either that the interview question 142 is shown or that it is hidden. The expressions can be ordered in the same way as the navigation section 154, for the same or similar reasons.

### 1.1.1.2.4 Row Options

Responses 144 to each interview question 142 in the question text can be marked as having special properties, for example to indicate that a particular selection eliminates all other selections as possibilities.

### 1.1.1.2.5 Imports

A question text file associated with the interview questions 142 can indicate some settings that apply globally to the rule set, such as its name. The question text file can also contain imports, which can be imported rule sets to be used in conjunction with a particular one or more current rule sets (e.g., 145). The imported rule sets can be referenced within the dynamic interview 140. The interview questions 142 associated with the imported rule set may navigate to interview questions 142 in an imported survey. This can create a relationship of parent module and sub-module between the importing and imported rule sets named.

### 1.1.1.2.6 Non-Question Based Inputs

Structured data 148 not provided directly through patient questions (e.g., imported or acquired from other sources, such as low, normal or high range lab results 162, averages or discrete data points from medical devices 164, demographic or clinical data from an electronic medical record (EMR) 166, and/or other 3^{rd} party systems or information 168) can also be processed as part of the evaluation 150 by the evaluator logic section 155.

### 1.1.2 Clinical Logic Rules

Based on the expressions formed by the question 142 and row option combinations in the dynamic interview 140, various clinical logic rules 145 can be applied:

### 1.1.2.1 Termination

Each question 142 can have one or more responses 144, which can indicate that the evaluation 150 should be terminated, and that no diagnosis will be reached. The evaluator logic section 155 can make such a termination decision based on the one or more termination responses 144. In the context of a patient taking a survey or dynamic interview 140, when a patient submits a response 144 that results in termination, the online evaluation 150 can end and the patient can be instructed to see their HCP for in-person care. An explanation of the specific cause of the termination can also be provided to the patient.

### 1.1.2.2 Chart Note Components

Files that describe the dynamic interview 140 can be used to generate a form that can be appropriate for HCP review and for permanent documentation storage in an HCP's record-keeping database 180 and/or in secure storage 182. These include a number of files that, when combined and processed by the evaluator logic section 155, can produce a human readable document, such as the customized treatment plan 190, the automated chart note narrative 132, and/or the detailed clinical summary 196, which the HCP can sign.

The chart note components of the chart note narrative 132 can be evaluated so that an electronic document can be generated, suitable for HCP review and for permanent documentation storage in the HCP's record-keeping database 180, which describes the details of the presenting issue, as well as all diagnostic and treatment decisions that have been made about it. Any particular response 144 to a question 142 in the question text may be associated with text to be shown or not shown in the chart note components of the chart note narrative 132.

### 1.1.2.3 Diagnosis Weights

The diagnosis weights 185 can be evaluated based on each response 144 given. Any given response 144 can have the effect of increasing, decreasing, and/or ruling out a particular diagnosis weight 185 and/or diagnosis. A given response 144 can also have no effect on a particular diagnosis weight 185 and/or diagnosis. Each row in this data structure can indicate a unique question 142, a unique row within that question 142, and one or more weights 185 to be applied to the available diagnoses (e.g., 125-1, 125-2, through 125-3), or a marker to indicate that this response 144 rules a diagnosis out completely.

The diagnosis weights 185 can be included in a structured data file, which can provide a mapping between individual question responses 144 and diagnoses (e.g., 125-1, 125-2, through 125-3), indicating how much each diagnosis should be weighted based at least on the given answer 144, and whether or not a diagnosis should be ruled out.

### 1.1.2.4 Clinical Translation

The clinical translation of each question 142 and response 144 in the dynamic interview 140 can be part of the rule set 145. The clinical translation can be conveyed in specific clinical language in the output (e.g., 190, 192, 194, 132, 196), which can be used by the HCP.

### 1.1.2.5 Formulary

The formulary table 128 can be stored as a structured data file. Such a structured data file can describe the treatment name and sig (i.e., the dosage, frequency, and other pertinent data) for each treatment option (e.g., 130-1, 130-2, through 130-3), as well as the conditions under which a particular drug might be applicable or contraindicated.

The formulary table 128 can describe medication options, which may be used to treat one or more of the diagnoses (e.g., 125-1, 125-2, through 125-3). The formulary table 128 can also contain logical expressions 138, which can be evaluated to determine when a given medication may be applicable to a particular diagnosis (e.g., 125-1, 125-2, through 125-3), and/or when a medication is contraindicated. Each row in this data structure can indicate a single medication, the sig for that medication, and/or a series of expressions to evaluate and/or indicate that the medication is applicable or contraindicated, if any expression evaluates to true.

The formulary table 128 can also be organized into groups of medications, where multiple medications are possible to treat a single condition. The formulary table 128 can also indicate which of these should be the suggested treatment option (e.g., 130-1, 130-2, through 130-3), for a given diagnosis, by default.

### 1.1.2.6 Organization/Clinical Modules

The interview questions 142, clinical logic rules 145, logical expressions 157, or the like, described above can be sub-components of a single clinical module 160, around a related group of possible low-acuity diagnoses for a single chief complaint 165 (e.g., “ear discomfort,” “rash,” “chest pain,” etc.). Multiple clinical modules 170 can be loaded into the evaluator logic section 155 at runtime, and the chief complaint 165 can act as or otherwise influence the first selection made, when choosing which clinical module from among the clinical modules 170 to use to evaluate the data 115. Certain other clinical content files 175 can be used elsewhere, not necessarily as part of the rules engine 110.

### 1.2 Responses

1.2.1 The second set of inputs to the evaluator logic section 155 is a sequence of responses 144, which together can form a response set. Each response 144 may be a piece of text, a number, and/or a Boolean true/false, associated with the particular question 142 and row (e.g., a response might be described as {Q1.B: true} which means that in the question 142 having label Q1, the row having label B within that question 142 has a value of true).

Each response set can also store the type of question it is associated with. Partial response sets can also be stored when the input data is coming from a human being interacting with the system as a survey or dynamic interview 140, i.e., a single question 142 at a time. This need not affect the evaluation 150.

### 1.3 Evaluator Logic Section

The evaluator logic section 155 can load the clinical logic rules 145 at startup and compile them into a series of data structures and operations.

### 1.3.1 Initialization

The evaluator logic section 155 can be given an interview 140 to process together with a clinical module 160.

### 1.3.2 Operation

The evaluator logic section 155 can apply each response 144 to the questions 142 in the rule set, one at a time, at the time of each response submission, beginning with the first question.

Before evaluating each question 142, the evaluator logic section 155 can check the question's visibility section 156 by evaluating each of the expressions there, one at a time. If the question 142 is determined to be not visible, the evaluator logic section 155 can skip any responses 144 to that question and begin at the following question. Next, the evaluator logic section 155 can apply the visibility options of rows in the question to those rows, to determine which rows are available.

### 1.3.3 Results of Question Evaluation

The responses 144 to the question 142 can be applied, in order. Any response 144 that refers to a row that is no longer visible is an error, as is a response that is the wrong type for the question (e.g., a text response given to a radio question in which all question responses are mutually exclusive and evaluate to Boolean true/false).

When all responses for that question 142 are available, all relevant responses 144 can be evaluated against the rule set's diagnosis table. If any row in the question's responses matches a row in the diagnosis table, those diagnosis weights 185 can be applied to the relevant diagnoses (e.g., 125-1, 125-2, through 125-3). A running total of diagnosis weights 185 can be kept for each diagnosis (e.g., 125-1, 125-2, through 125-3), as well as whether each diagnosis (e.g., 125-1, 125-2, through 125-3) has been ruled out.

All relevant responses 144 can be evaluated against the rule set's formulary table 128. If any medication in the formulary table 128 is determined to be contraindicated by the rows in the responses 144, that contraindication can be remembered for that particular interview 140.

Any navigation section 154 can be evaluated to determine whether the evaluator logic section 155 should skip ahead to a different question 142 instead of starting at the next question. If any navigation expression 159 evaluates to true, the result of evaluating that expression can be a question label, and the question can navigate there next. Standard navigation may reach labeled questions in sub-modules, which can be imported by the parent module where evaluation began.

The navigation section 154 can include a navigation to the special “terminate” question, which can be the final question to be evaluated. The terminate question is a special-case question that only contains a message and ends the interview 140, with no diagnosis reached.

The navigation section 154 can also indicate a “continue.” This is special case question, which sets the evaluator's next question to a question in a parent module. It can be an error to encounter the continue navigation in a rule set without a parent (i.e., it can be reachable only in sub-modules). The evaluator logic section 155 can continue this process with each question it reaches, in turn, until all questions 142 have been processed.

### 1.3.4 Evaluation Output

The process of evaluating all responses 144 against the diagnosis weights 185 can produce at least one of: i) a single suggested diagnosis, consisting of the one diagnosis from among the choices of diagnoses (e.g., 125-1, 125-2, through 125-3), which has the highest weight or score, ii) multiple suggested diagnoses from among the choices of diagnoses (e.g., 125-1, 125-2, through 125-3), when more than one diagnosis is tied with the highest weight or score, or iii) no diagnosis, when all diagnoses (e.g., 125-1, 125-2, through 125-3) have been ruled out by evaluation.

This process can also produce a list of treatment options (e.g., 130-1, 130-2, through 130-3). The treatment options (e.g., 130-1, 130-2, through 130-3) can include a set of medications retrieved from the formulary table 128. If any of the medications in the treatment options (e.g., 130-1, 130-2, through 130-3) are contraindicated by responses 144 in this interview, this information can be included in the output (e.g., 190, 192, 194, 132, 196).

### 2 Patient Data Collection

The automated medical computer logic apparatus 105 can include the survey presentation section 195. The survey presentation section 195 can display a survey or dynamic interview 140 on a screen to a potential patient, one question at a time, storing their responses 144 as the dynamic interview 140.

The survey presentation can mirror the way the evaluator logic section 155 operates, and can use the same or similar set of data files: the interview 140 and the clinical logic rules 145. The output of the survey can include the response set 144.

### 2.1 Question Display

Each section in the question text file can be a human-readable question 142 with a series of human-readable responses 144. In each question 142, a field can indicate which type of control is to be displayed. There are many possible question types, any of which may be used as input data for the evaluator logic section 155.

For example, a drug input question can display an open text field and allow the patient to search for any medication known about in the industry-standard RxNorm medication database, in such a way that it is easy for a non-expert user to find the medications they are taking.

The question 142 can be displayed to the user along with a particular input control, which can be translated into the appropriate control for the medium. For example, a single-variable, mutually exclusive question 142 can be rendered as a radio input when the survey is displayed, for example, on an HTML page. A multivariable question 142 can be rendered as a checkbox input in the same medium.

### 2.2 Response Handling

When the user indicates their answer, the apparatus 105 can store the response 144, then pass the response values to the evaluator logic section 155. The evaluator logic section 155 can make any updates to the diagnosis (e.g., 125-1, 125-2, through 125-3), to the treatment options (e.g., 130-1, 130-2, through 130-3), and/or to determine the next question 142 to navigate to, as described in the rules engine 110 section above.

As part of the transaction of storing the responses 144 to a question 142, the survey presentation section 195 can then return with the next question 142 to be displayed and can display it the same or similar way.

This process can continue until the evaluator logic section 155 indicates there are no more questions 142 to be displayed, and the interview ends, typically with a message on the screen indicating to the user that they are done answering the questions 142.

### 2.3 Survey Termination

If the user reaches the “terminate” question at any point, a message can be displayed by the survey presentation section 195 explaining why the clinical logic has directed them there, and/or instructing the patient to arrange for an in-person visit with the HCP. This can be either because i) the symptoms they have indicated have ruled out all diagnoses, ii) the patient has indicated that there are no applicable symptoms at all, and/or iii) the patient's symptoms mean that a high-acuity (serious) medical condition is probable. In this case, the message can instruct the user to make an appointment with the doctor right away.

### 2.4 Response Storage

When the user (e.g., patient) exits the survey, their data can be stored in a form that can later be loaded and displayed to the user's HCP. The survey or dynamic interview 140 can be given a status of queued, meaning it is ready for review by a HCP.

The data can be stored in such a way that it can only uniquely identify a patient for up to a predefined period of time, e.g., 24 hours. After the predefined period of time, the identifying information can be stripped off and stored separately. This method of storage can anonymize the data to prevent others, including malicious entities, from acquiring the data identifying the person involved in any particular interview. Cryptographic key pairs can be used to retrieve the stripped off identifying information from archive storage if needed, as a backup against losing the data on the record-keeping database 180 or secure storage 182, and/or if the data needs to be otherwise reconciled.

### 3 Interview Queue

All interviews 140 can be added to a queue 174 as they are received by the automated medical computer logic apparatus 105. The queue 174 can include metadata about the dynamic interview 140, such as the patient's primary-care provider, the patient's name, the time the interview 140 was completed, and/or the label of the rule set associated with the interview 140. Various changes in queue state can trigger a provider alert (e.g., SMS message, email, pager message, mobile push notification, etc), which can include any of the metadata associated with the queued interview.

The HCP can use a built-in control to select an interview 140 from this list. When an item is selected from the queue 174, that particular interview 140 can change status and become in a review mode. No other HCP can work on this particular interview 140 while it is in this mode. Under certain circumstances (e.g., after a predefined period of time), an interview that is in the review mode may revert to a status of queued.

### 4 Presentation of Clinical Information

The automated medical computer logic apparatus 105, after analyzing the interview 140, can present recommendations (e.g., 190 and/or 132) to the HCP. The recommendations can be structured in such a way that the HCP can efficiently review patient information, make an informed diagnosis, provide treatment and education, and/or document the encounter.

### 4.1 Patient Overview Actions

The initial interview review screen can be the patient overview. The most prominent visual elements can be the choice of diagnosis diagnoses (e.g., 125-1, 125-2, through 125-3), the treatment options (e.g., 130-1, 130-2, through 130-3), and/or the patient education 197.

### 4.1.1 Choice of Diagnosis

The HCP can be shown a choice of possible diagnoses (e.g., 125-1, 125-2, through 125-3) for the given chief complaint 165. This list can be filtered to remove any ruled-out diagnoses, which were so marked by the evaluator logic section 155. Of the remaining diagnoses (e.g., 125-1, 125-2, through 125-3), when one of the diagnoses is weighted or scored higher than all the others, that choice can be visually identified. Otherwise, the diagnosis need not be pre-selected, and a message can inform the HCP that more than one possible diagnosis has scored the highest. The highest weighted or scored diagnoses can be identified in the selection mechanism.

The HCP can select from among the presented diagnosis, or can change the diagnosis to any other diagnosis that, in their medical opinion, is a more accurate diagnosis than the diagnoses presented by the evaluator logic section 155. In other words, the HCP ultimately determines the diagnosis, which can be based at least in part on the presented information.

### 4.1.2 Treatment Options

The HCP can be shown treatment options (e.g., 130-1, 130-2, through 130-3), including medications, which may be used to treat the diagnosis. The list of treatment options (e.g., 130-1, 130-2, through 130-3) can depend on the determined diagnosis. The list can update dynamically if the recommended diagnosis is changed. The medications can be organized by category, so that an entire category of medications (for example, “antibiotics”) can be removed from the treatment plan at once. Any contraindications the evaluator logic section 155 finds need not appear in the list of treatment options (e.g., 130-1, 130-2, through 130-3). Alternatively or in addition, any contraindications can be made to be “not selectable.”

### 4.1.3 Patient Education

The HCP can be shown a list of the information that can be sent to the patient if the interview 140 is approved and signed. This information can be tailored to the particular diagnosis currently chosen. HCPs may manually select or deselect specific components of patient education 197 to be provided.

### 4.2 Clinical Summary

Detailed information collected during the dynamic interview 140 can be the HCP's primary means of making a diagnosis. This information can be displayed as part of the patient overview.

### 4.2.1 Presenting History

The presentation (e.g., detailed clinical summary 196) can include a detailed description of the patient's presenting history in language the HCP can understand. In some embodiments, only pertinent and diagnostically useful information derived from the interview 140 is shown here.

### 4.2.2 Questions and Answers

The Q&A of the dynamic interview 140 can also be included in the detailed clinical summary 196. This can include a listing of all questions 142 evaluated, and the responses 144 to them, in an unambiguous and human-readable format, such that the HCP has the ability to reconcile the information in the presenting history with the actual responses in the dynamic interview 140.

### 4.3 HCP Actions

The HCP can be provided with the controls to act on the presentation of interview information in the detailed clinical summary 196. Once the HCP has made any diagnostic and treatment selections, they have control mechanisms available to ask the patient to physically come in to the office. The patient's interview data can be removed from the automated medical computer logic apparatus 105. For example, the virtual visit can be converted to a physical in-person visit. Alternatively, a signed chart note (e.g., 132) can be created, and then the interview 140 removed from the automated medical computer logic apparatus 105. The HCP can be required to provide proof of identity at the moment of the status change from virtual to in-person visit. When one of these status changes occurs, the interview 140 can trigger a series of actions that handle the order.

### 5 Order Handling

There are at least two ways for a dynamic interview 140 to be processed and removed from the automated medical computer logic apparatus 105: it can be either i) signed, or ii) converted to in-person. The dynamic interview 140 may also revert to the queue 174 under certain circumstances, but can continue to be active within the apparatus 105 when that happens.

### 5.1 In-Person Conversion

If the HCP changes the status to an in-person conversion, the patient can be immediately sent a notification. The interview data can be immediately stored in the HCP's record-keeping database 180 and/or secure storage 182.

### 5.1.1 Record Storage

The automated medical computer logic apparatus 105 can connect to the HCP's record-keeping database 180 or EMR system, and send the full details of the interview or clinical summary 196, including the HCP's actions in the patient overview. In the case of an in-person conversion, information about diagnosis or treatment plan need not be stored, since no diagnosis was made. All other information that was collected can be sent for storage using whatever protocols are understood by the EMR.

### 5.1.2 Queue Removal

When a dynamic interview 140 is converted to in-person, it can be removed from the queue 174. No further work need be done on it by the HCP via the automated medical computer logic apparatus 105.

### 5.1.3 Patient Notification

The patient can be notified. The form of the notification can take one of several forms, for example, through a mobile push notification, with an email, or with an SMS text message. The information in the notification can depend on the medium. The information can include only enough information for the patient to identify the time of the interview 140, and to understand that no diagnosis will be given through the automated medical computer logic apparatus 105. The information can direct the patient to contact their HCP directly to schedule an appointment.

### 5.1.4 De-Identification, Archival, Removal

The automated medical computer logic apparatus 105 can make a copy of the information for the archive, and this copy can have all uniquely identifying patient characteristics removed from it, so the resulting information can be used to calculate aggregate statistics, but cannot be used to uniquely identify a particular patient's interaction with the apparatus 105. The original copy of the interview 140 containing identifying information can be deleted.

### 5.2 Signed Chart Note

When the HCP creates a signed chart note (e.g., signed 132), the patient can be immediately sent a notification. The interview data can be immediately stored in the HCP's record-keeping database 180 and/or in secure storage 182. Medications, if any, can be sent to the patient's pharmacy.

### 5.2.1 Record Storage

Storage of the signed chart note (e.g., 132) can be identical or similar to the record storage done for an in-person conversion, with the following modification: the EMR can be sent, or can otherwise store, a completed chart note 132 that includes an assessment and treatment plan.

### 5.2.2 Queue Removal

Queue removal can be done in the same or similar fashion as an in-person conversion. In other words, an interview 140 can be removed from the queue 174 in the same or similar fashion as an in-person conversion, described above.

### 5.2.3 Patient Notification

Patient notification can be the same or similar to the notification done for an in-person conversion, except that the information sent can direct the patient to read their diagnosis and treatment plan. For example, a hyper-text link can lead to a web page containing the pertinent education 197, which can include an after-visit summary (AVS), an embedded document, and/or something else. If the HCP has selected medications to prescribe, the patient can be directed to pick them up at a particular pharmacy.

One or more copies of the patient's education information 197 including the AVS can be stored on secure storage 182 of the automated medical computer logic apparatus 105, in a secure document store, in such a way that it can be completely anonymous to the automated medical computer logic apparatus 105. In some embodiments, the secure storage 182 can only be reached by a combination of factors whereby the user proves they are the rightful recipient of this information, but where not enough information is available for anyone else to identify who the document or information belongs to.

### 5.2.4 Prescription Routing

When the HCP has selected medications for the patient to take, the full prescription information can be sent electronically as an RX delivery 192 to a pharmacy selected by the patient during the interview 140. The information can be sent over whatever Rx transmission protocols that pharmacy supports.

### 5.2.5 De-Identification, Archival, Removal

De-identification, archival, and/or removal can be done in the same or similar fashion as with an in-person conversion, as described above.

### 5.3 Return to Queue

Under some circumstances, an interview 140 is not acted on by the HCP, and it is instead returned to a status of queued in the queue 174, so that it can appear in the queue 174 again. This can happen if the HCP closes her view of the interview 140, takes too long before taking any action (times out), and/or manually selects an option that sends the patient back to the queue 174. In this circumstance, the only change can be to the status of the interview 140 back to queued state. Any changes that were made by the HCP need not be kept.

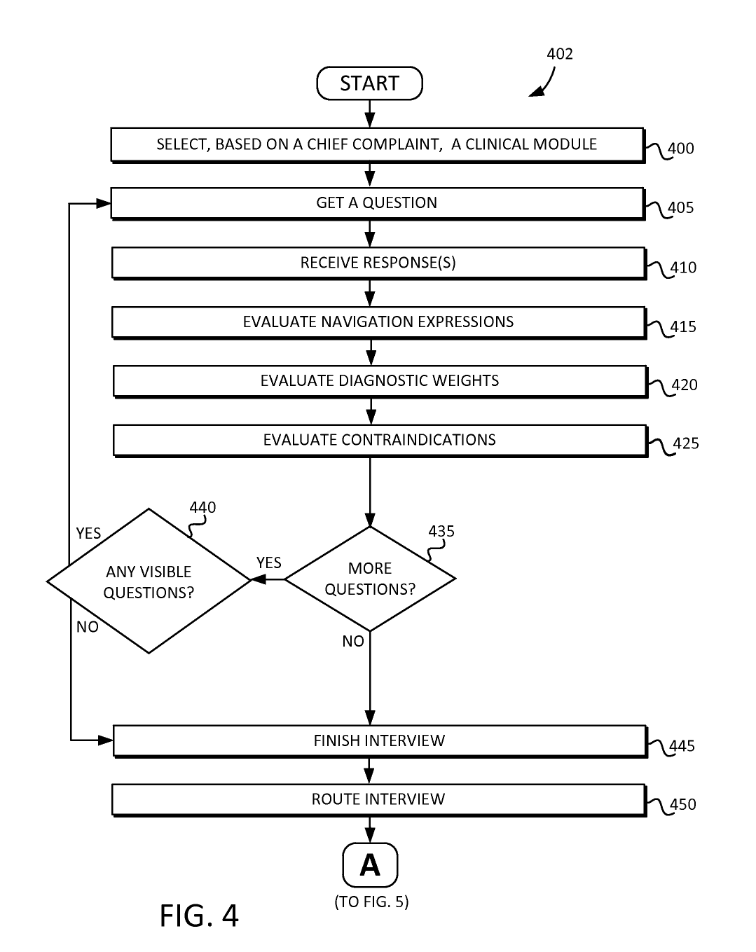

FIG. 4 shows a flow diagram 402 illustrating a technique for performing a medical evaluation in accordance with various embodiments of the present invention.

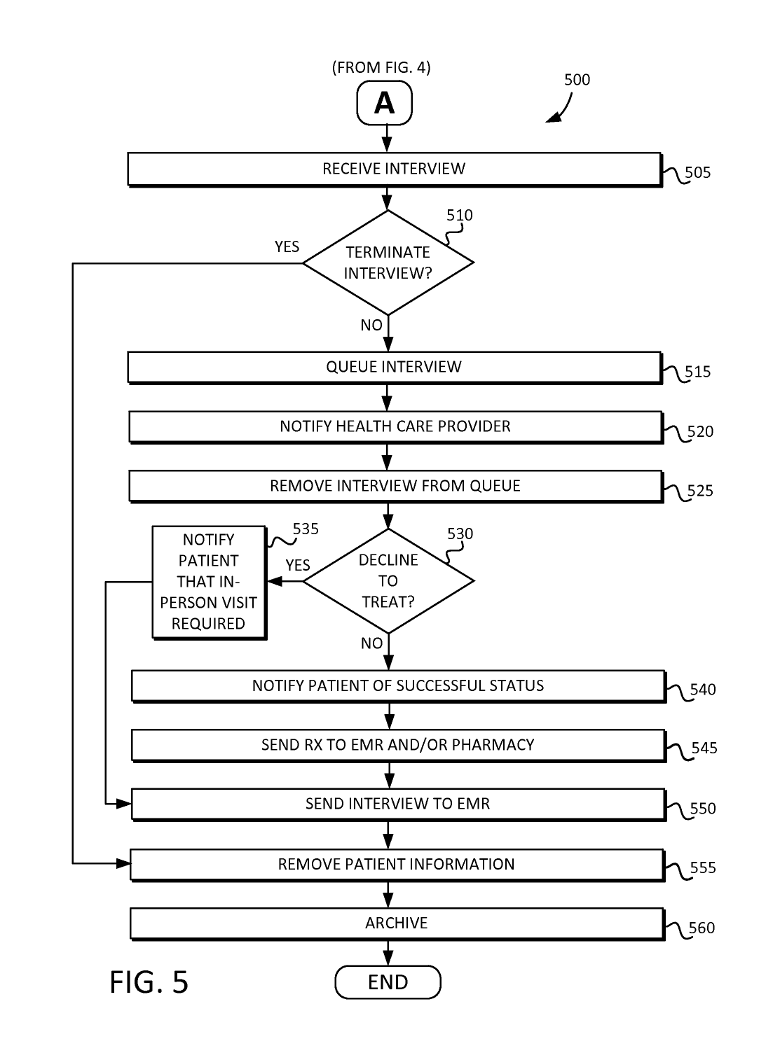

The technique can begin at 400, where a clinical module (e.g., 160) including a rules set can be chosen, based on a chief complaint (e.g., 165 of FIG. 1) from the patient, after which the flow can proceeds to get question at 405, receive response(s) at 410, evaluate navigation expressions at 415, evaluate diagnosis weights at 420, and evaluate contraindications at 425. A determination can be made at 435 whether there are more interview questions. If YES, the flow can proceed to 440, as further described below. Otherwise, if NO, the flow can proceed to 445 to finish the interview and then to 450 to route the interview. At 440, another determination can be made whether there are any visible questions remaining. If YES, the flow can returns to 405 to get a next question. Otherwise, if NO, the flow can proceed to 445 to finish the interview and then to 450 to route the interview. If the flow takes the path to route the interview at 450, then the flow can continue through the ‘A’ to FIG. 5, discussed below.

Although the steps shown in FIG. 4 are illustrated in a particular order, it will be understood that the steps can be performed in a different order, and/or with intervening steps.

FIG. 5 shows a flow diagram 500 illustrating a technique for routing a medical interview in accordance with various embodiments of the present invention.

The technique can begin at 505, where an interview is received through the ‘A’ from FIG. 4, discussed above. A determination can be made at 510 whether to terminate the interview. If YES, the flow can proceed to 555 where the patient information can be removed, and then to 560, where the patient information can be archived. Otherwise, if NO, meaning that the interview is not to be terminated, the flow can proceed to 515, where the interview can be placed in a queue (e.g., 174 of FIG. 2). The flow can then proceed to 520 where the HCP can be notified and then to 525 where the HCP can remove the interview (e.g., 140 of FIG. 2) from the queue (e.g., 174 of FIG. 2).

A determination can be made at 530 whether to decline to provide remote medical treatment. Such determination can be made by the HCP. If YES, the patient can be notified at 535 that an in-person visit is required, after which the interview (e.g., 140 of FIG. 1) can be sent to, or otherwise stored in, an EMR at 550. Otherwise, if NO, meaning that medical treatment is not declined, then the flow can proceed to 540 where the patient can be notified of a successful remote treatment status, after which an Rx prescription request and/or approval can be sent to an EMR and/or pharmacy at 545. In other words, an authorization can be automatically sent to a pharmacy to fill a prescription medication. Moreover, the authorization to fill the prescription medication can be automatically stored in the EMR. After the interview is sent to the EMR at 550, the flow can proceed to 555, where the patient information can be removed, and then to 560, where the patient information can be archived.

Although the steps shown in FIG. 5 are illustrated in a particular order, it will be understood that the steps can be performed in a different order, and/or with intervening steps.

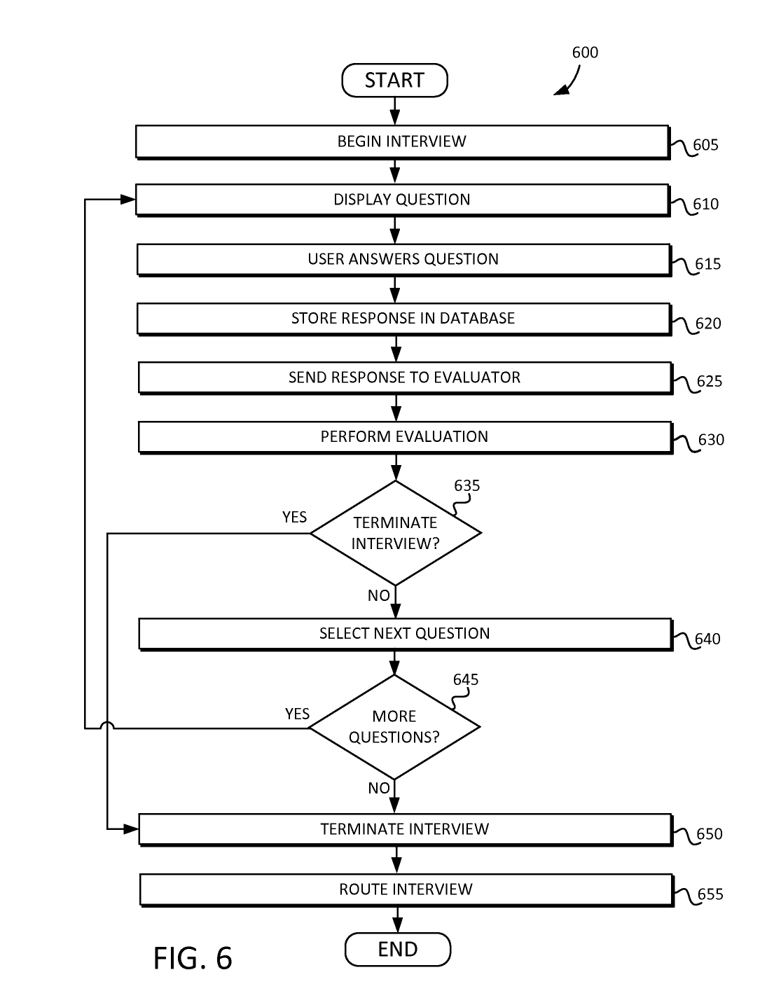

FIG. 6 shows a flow diagram 600 illustrating a technique for performing a dynamic medical interview in accordance with various embodiments of the present invention.

The technique can begin at 605, where dynamic interview is begun, after which the flow can proceed to display a question at 610, a user can answer a question at 615, the user's response can be stored in a database at 620 (e.g., 180 and/or 182 of FIG. 3), a response can be sent to evaluator (e.g., 155 of FIG. 1) at 625, and an evaluation can be performed at 630, as described in detail above. A determination can be made at 635 whether to terminate the interview. If YES, the flow can proceed to 650 where the interview can be finished, and then to 655 to route the interview. Otherwise, if NO, the flow can proceed to 640 where a next question can be selected.

Another determination can be made at 645 whether there are more questions. If NO, the flow can proceed to 650 where the interview can be finished, and then to 655 to route the interview. Otherwise, if YES, meaning that there are more questions, the flow can return to 610 and another question can be displayed and the processing flow can continue.

It will be understood that the elements and steps of each of the flow diagrams of FIGS. 4 through 6 need not occur in the order illustrated, but rather, the elements and steps can occur in a different order, or with intervening steps. Nevertheless, the elements and steps can be specified to occur in the order illustrated.

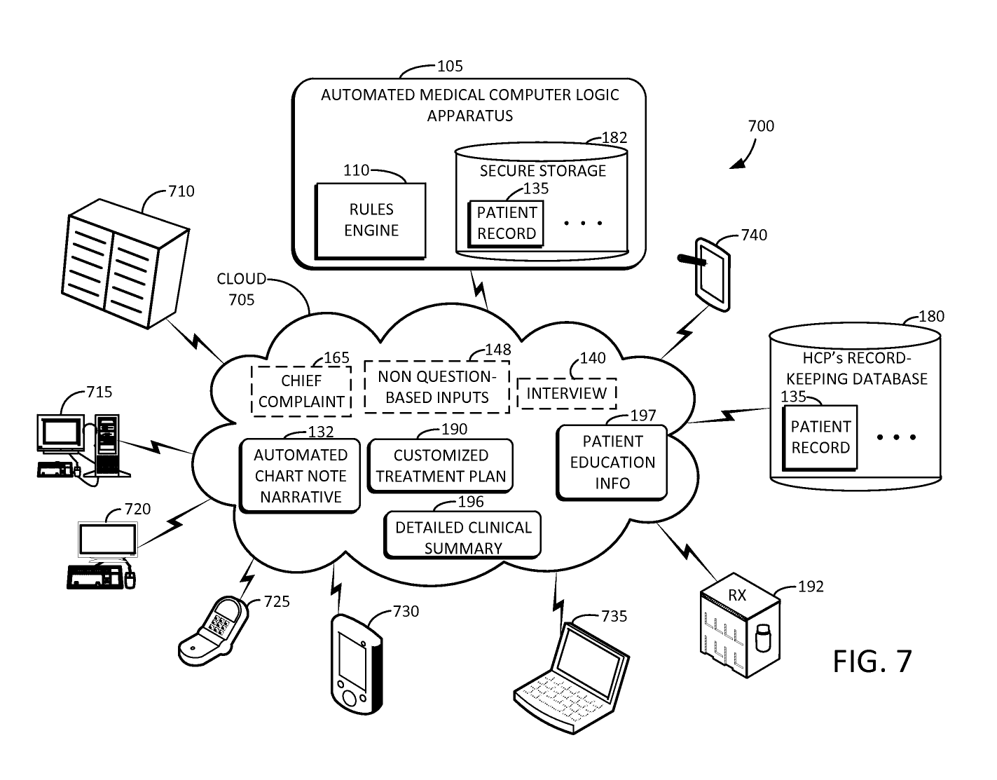

FIG. 7 illustrates an example block diagram of an example automated medical computer logic cloud-based system 700 in accordance with various embodiments of the present invention. The automated medical computer logic cloud-based system 700 can include a cloud 705 that interconnects the automated medical computer logic apparatus 105 (of FIG. 1), the HCP's record-keeping database 180, a pharmacy 192, and other computing devices accessible by a patient and/or medical professional such as a tablet 740, a laptop computer 735, a smart phone 730, a phone 725, a terminal 720, a personal computer 715, or the like. A remote database 710 can be connected to the automated medical computer logic apparatus 105 via the cloud 705, and can store outputs (e.g., 190, 192, 194, 132, 196 of FIG. 1) from the automated medical computer logic apparatus 105.

Various inputs and outputs to and from the automated medical computer logic apparatus 105 can be transmitted and/or stored via the cloud 705. For example, the chief complaint 165 can be received by the apparatus 105 from a patient by way of a computing device (e.g., 740, 735, 730, 725, 720, 715, or the like) and the cloud 705. By way of another example, the dynamic interview 140 can be carried out with the patient by way of displays and input interfaces of the computing devices (e.g., 740, 735, 730, 725, 720, 715, or the like), and by way of the cloud 705. By way of yet another example, the non question-based inputs 148 can be received by the apparatus 105 via the cloud 705. By way of still another example, outputs from the apparatus 105 such as the automated chart note narrative 132, the customized treatment plan 190, the detailed clinical summary 196, and/or the patient education information 197, can be transmitted to a computing device owned or operated by the HCP or patient via the cloud 705. Such information can be gathered and transmitted remotely, in most cases without the requirement of an in-person meeting.

### DEFINITIONS

After Visit Summary (AVS): Patient facing document that summarizes a clinical encounter, including diagnosis, treatment plan, and/or education.

Chart Note: Provider facing document that summarizes a clinical encounter, including clinical findings, history, assessment, and/or plan of treatment.

Chief complaint: The sign, symptom or condition that a patient is seeking care for.

Health Care Provider (HCP): a physician, nurse practitioner, physician assistant, and/or a company who employs the physician, nurse practitioner, and/or physician assistant.

Medical record: A permanent, medico-legal record of a patient's medical care, which can include at least one of: chart notes, lab results, imaging records, and/or pathology results.

User: As used herein, the term “user” can refer to either a patient or an HCP, or both, depending on the context.

The following discussion is intended to provide a brief, general description of a suitable machine or machines in which certain aspects of the invention can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the invention can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Embodiments of the invention may include a non-transitory machine-readable medium comprising instructions executable by one or more processors, the instructions comprising instructions to perform the elements of the embodiments as described herein. Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An automated medical diagnosis and treatment support apparatus, comprising:
a rules engine including a plurality of clinical modules each including one or more interview questions, a module selector configured to select a clinical module from among the plurality of clinical modules based on a chief complaint received from a patient, an evaluator logic section configured to process the selected clinical module, and a survey presentation section configured to conduct a dynamic interview with the patient based at least on a selected subset of interview questions from among the one or more interview questions from the selected clinical module.

2. The automated medical diagnosis and treatment support apparatus of claim 1, further comprising:
a summary and plan generator configured to automatically generate a customized treatment plan in human readable form based at least on responses received from the patient during the dynamic interview; and
a chart note creation engine configured to generate an automated chart note narrative that reads like and appears as a subjective, objective, assessment, and plan (SOAP) note.

3. The automated medical diagnosis and treatment support apparatus of claim 2, further comprising:
an automated prescription engine configured to cause an automated prescription medication delivery to a selected pharmacy.

4. The automated medical diagnosis and treatment support apparatus of claim 2, further comprising:
an electronic medical record (EMR) update engine configured to cause an EMR update to occur, including at least one of the customized treatment plan, medical prescription information associated with the automated prescription medication delivery, or the chart note narrative.

5. The automated medical diagnosis and treatment support apparatus of claim 2, wherein:
the summary and plan generator is configured to automatically generate a detailed clinical summary including a detailed description of a presenting history of the patient and diagnostic information derived from the interview; and
the summary and plan generator is configured to generate patient education information including an after-visit summary.

6. The automated medical diagnosis and treatment support apparatus of claim 1, wherein:
the chief complaint includes a chief medical-related complaint from the patient;
the module selector of the rules engine is configured to receive the chief complaint from the patient; and
the module selector is configured to select the clinical module from among the plurality of clinical modules based on the received chief complaint prior to the survey presentation section beginning the dynamic interview with the patient.

7. The automated medical diagnosis and treatment support apparatus of claim 6, wherein:
the evaluator logic section is configured to receive non question-based inputs, and to determine the selected subset of interview questions from among the one or more interview questions from the selected clinical module that are asked the patient based at least on the non question-based inputs; and
the survey presentation section is configured to ask the patient the selected subset of interview questions from among the one or more interview questions, and to gather interview responses from the patient to the selected subset of interview questions.

8. The automated medical diagnosis and treatment support apparatus of claim 7, wherein:
the evaluator logic section is configured to determine the selected subset from among the one or more interview questions from the selected clinical module that are asked the patient based at least on one or more previous interview responses from among the interview responses gathered by the survey presentation section.

9. The automated medical diagnosis and treatment support apparatus of claim 8, wherein:
the evaluator logic section is configured to map the interview responses gathered by the survey presentation section to a plurality of diagnoses; and
the evaluator logic section is configured to assign a diagnosis weight to each of the plurality of diagnoses based at least on the interview responses gathered by the survey presentation section.

10. The automated medical diagnosis and treatment support apparatus of claim 9, wherein:
the evaluator logic section is configured to determine a single suggested diagnosis from among the plurality of diagnoses having a highest weight; and
the evaluator logic section is configured to suggest treatment options associated with the single suggested diagnosis having the highest weight.

11. The automated medical diagnosis and treatment support apparatus of claim 9, wherein:
the evaluator logic section is configured to assign the diagnosis weight to each of the plurality of diagnoses based at least on the selected clinical module, the interview responses, clinical logic rules of the selected clinical module, and the non question-based inputs.

12. The automated medical diagnosis and treatment support apparatus of claim 11, further comprising:
a formulary table including one or more medications and the treatment options associated with the single suggested diagnosis,
wherein the evaluator logic section is configured to access information about the one or more medications and the treatment options, and to associate such information with the single suggested diagnosis.

13. The automated medical diagnosis and treatment support apparatus of claim 9, wherein:
the evaluator logic section is configured to determine multiple suggested diagnoses from among the plurality of diagnoses when more than one diagnosis have equal highest diagnosis weights.

14. The automated medical diagnosis and treatment support apparatus of claim 9, wherein:
the evaluator logic section is configured to determine no suggested diagnosis from among the plurality of diagnoses when all of the plurality of diagnoses are ruled out by the evaluator logic section.

15. The automated medical diagnosis and treatment support apparatus of claim 1, wherein:
the evaluator logic section is configured to terminate the dynamic interview based on one or more responses received from the patient during the dynamic interview; and
the survey presentation section is configured to display a message instructing the patient to arrange for an in-person visit with a health care provider.

16. A method for automatically providing a medical diagnosis and treatment support, the method comprising:
receiving, by an automated medical diagnosis and treatment support apparatus, a chief complaint from a patient;
selecting, by a module selector of the automated medical diagnosis and treatment support apparatus, based on the chief complaint, a clinical module from among a plurality of clinical modules, wherein the selected clinical module includes a plurality of interview questions and clinical logic rules associated with the chief complaint;
receiving, by a rules engine of the automated medical diagnosis and treatment support apparatus, the selected clinical module;
receiving, by the rules engine, non question-based inputs;
selecting, by the rules engine, a subset of the plurality of interview questions based at least on the non question-based inputs;
conducting, by a survey presentation section, a dynamic interview with the patient including the subset of the plurality of interview questions;
receiving, by the rules engine, a plurality of responses from the patient to the subset of the plurality of interview questions; and
determining, by the rules engine, a next question based at least on the non question-based inputs and the responses from the patient to the subset of the plurality of interview questions.

17. The method for automatically providing a medical diagnosis and treatment support of claim 16, the method further comprising:
evaluating, by the rules engine, navigation expressions associated with the subset of the plurality of interview questions;
evaluating, by the rules engine, diagnostic weights associated with a plurality of possible diagnoses associated with the chief complaint;
assigning, by the rules engine, the diagnostic weights to each of the plurality of possible diagnoses associated with the chief complaint;
determining, by the rules engine, a next question based at least on the non question-based inputs and the responses from the patient to the subset of the plurality of interview questions;
adjusting, by the rules engine, the assigned diagnostic weights based at least on the responses from the patient to the subset of the plurality of interview questions; and
assigning, by the rules engine, the adjusted diagnostic weights to each of the plurality of possible diagnoses associated with the chief complaint.

18. The method for automatically providing a medical diagnosis and treatment support of claim 17, the method further comprising:
determining, by the rules engine, whether to terminate the dynamic interview based on one or more the responses from the patient;
when it is determined that the interview should not be terminated, placing the dynamic interview in a queue;
notifying a health care provider of the dynamic interview in the queue;
removing the dynamic interview from the queue;
determining whether to remotely treat the patient based at least on the dynamic interview removed from the queue;
when determining not to remotely treat the patient, notifying the patient that an in-person visit to the health care provider is required; and
when determining to remotely treat the patient, notifying the patient of a successful remote treatment status, and automatically sending an authorization to a pharmacy to fill a prescription medication.
